(19) United States
(12) Patent Application Publication
(10) Pub. No.: US 2009/0163609 A1
(43) Pub. Date: Jun. 25, 2009

(54) LOW DENSITY AND HIGH DENSITY POLYETHERIMIDE FOAM MATERIALS AND ARTICLES INCLUDING THE SAME

(76) Inventors: Richard D. Lassor, Averill Park, NY (US); Randall Todd Myers, Pittsfield, MA (US); Michael Kane Pilliod, San Francisco, CA (US); Erich Otto Teutsch, Richmond, MA (US)

Correspondence Address: SABIC - 08CT;SABIC Innovative Plastics - IP Legal, ONE PLASTICS AVENUE, PITTSFIELD, MA, 01201-3697, US

(21) Appl. No.: 11/961,230

(22) Filed: Dec. 20, 2007

(51) Int. Cl. C08G 73/10

(52) U.S. Cl. 521/55; 521/184

(57) ABSTRACT

Polyetherimide foam materials, articles that include these foam materials and methods of making these foam materials and articles. The foam extrusion process uses selected blowing agents, equipment design and processing conditions to produce continuously extruded foam with a substantially uniform cell size in a lower density PEI foam, such as 25 to 50 g/L or a higher density PEI foam, such as 120 to 300 g/L. Due to the greater densities that can be produced as well as the characteristics inherent in polyetherimide articles, the resulting foam materials are suitable for a much broader range of applications.

### FIELD OF INVENTION

The present invention relates to polymer foams and, in particular, to polyetherimide foam materials having a selected density and articles and methods of making these foam materials and articles.

### BACKGROUND OF INVENTION

Foamed thermoplastic resins and products derived therefrom have achieved a considerable and significant commercial success in a number of fields. These foamed resins have been employed in aircraft and other structures for insulation and structural purposes. The electronics and appliance industry uses polymer foams for electrical and thermal insulation and for structural purposes. In many instances, it is beneficial for the polymer foams to be capable of withstanding higher heat environments. In order to use polymer foam in a high heat environment, a thermoplastic resin capable of withstanding higher heat environments is beneficially used.

One such high heat thermoplastic resin is polyetherimide. Polyetherimide (PEI) foam has been available for a number of years for highly demanding applications where electrical, mechanical and flame performance criteria can justify its application. Justification is difficult due to the high cost of the material and its limited availability. Both are due in part to the batch process employed for its manufacture. The batch process is generally inefficient, is difficult to control, is limited in choices of foam density that can be manufactured and is prone to defects. Nevertheless, foam made using the batch process has demanded a premium price and has been specified for a number of critical Department of Defense (DOD) applications.

The current “batch” process for PEI foam requires the use of chlorinated solvent and the production of large “buns” of foam that are inconsistent in density and cell structure as well as having defects due to contamination, large voids and un-foamed bits of polymer. These processes produce foamed polymer having a varying density of from 60 to 110 g/L. The buns are then cut to size in general density ranges of nominal 60, 80 and 110 g/L boards. The inconsistent quality, density and low yield of the batch-formed PEI foams drive the cost of the product too high for most applications.

In addition, these prior art batch processes do not provide PEI foam materials that are either lighter in density or heavier in density. As such, applications that could justify the use of a PEI foam, but that require a density less than 60 g/L or greater than 110 g/L, cannot use the PEI foams made by prior art processes that only produce foams in a density of from 60 to 110 g/L.

Accordingly, it would be beneficial to provide polyetherimide foam material having a broader range of possible foam densities. Many additional applications in commercial aircraft, high-speed rail and/or marine applications would be feasible if the density range could be expanded to meet specific requirements and/or if cost could be reduced by decreased resin usage, e.g. lower density and/or a more efficient means of production. It would also be beneficial to provide a process for forming a polyetherimide foam that enabled the production of low density and/or high density PEI foam materials.

### SUMMARY OF THE INVENTION

The present invention addresses the issues associated with the prior art by providing a polyetherimide (PEI) foam material and a method of making the same that enables the PEI foam to be manufactured in a greater variety of densities as compared to prior art PEI foams and/or methods. The processes of the present invention utilize one or more blowing agents, nucleating agents and/or CO2 as well as controlling the equipment and processing conditions to produce a foam with a substantially uniform cell size in densities ranging from 25 to 50 g/L for lower density foams and from 120 to 260 g/L for higher density foams. Due to the greater densities range as well as the characteristics inherent in polyetherimide articles, the resulting foam materials are suitable for a much broader range of applications.

Accordingly, in one aspect, the present invention provides a polyetherimide foam material having a density of 25 g/L to 50 g/L.

In another aspect, the present invention provides a polyetherimide foam material having a density of 120 g/L to 300 g/L.

In yet another aspect, the present invention provides an article that includes a polyetherimide foam material having a density of 25 g/L to 50 g/L.

In still another aspect, the present invention provides an article that includes a polyetherimide foam material having a density of 120 g/L to 300 g/L.

### BRIEF DESCRIPTION OF THE DRAWINGS

FIGS. 1 and 2 show the Log Differential Intrusion vs. Pore size for two foam materials made according to the continuous processes of the present invention.

FIGS. 3 and 4 show the Log Differential Intrusion vs. Pore size for two foam materials made according to the batch processes of the prior art.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.” Furthermore, all ranges disclosed herein are inclusive of the endpoints and are independently combinable.

As used herein, approximating language may be applied to modify any quantitative representation that may vary without resulting in a change in the basic function to which it is related. Accordingly, a value modified by a term or terms, such as “about” and “substantially,” may not to be limited to the precise value specified, in some cases. In at least some instances, the approximating language may correspond to the precision of an instrument for measuring the value.

The present invention provides a polyetherimide (PEI) foam material that can be controlled during manufacture to produce PEI foam materials having a much lower density than prior art foam materials, such as in a range from 25 to 50 g/L as well as being controlled to produce PEI foam materials having a much higher density than prior art foam materials, such as in a range from 120 to 300 g/L. By combining selected blowing agents, equipment design and processing conditions it is possible to produce continuously extruded foam with substantially uniform cell size in these lower and higher density ranges. These foams are therefore suitable for a much broader range of applications and due to the efficiencies of the process, can help provide a more cost effective product for use in less critical applications. The current, commercially available density range for PEI foam is nominally 60 to 110 g/L.

Accordingly, in one aspect, the present invention provides a foam material using an organic polymer. In one embodiment, polyimides may be used as the organic polymers in the foam materials. Useful thermoplastic polyimides have the general formula (I)

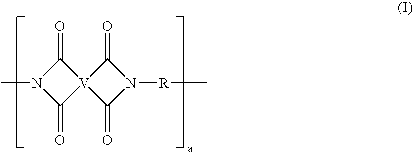

wherein a is greater than or equal to 10, and, in an alternative embodiment, greater than or equal to 1000; and wherein V is a tetravalent linker without limitation, provided the linker does not impede synthesis or use of the polyimide. Suitable linkers include, but are not limited to, (a) substituted or unsubstituted, saturated, unsaturated or aromatic monocyclic and polycyclic groups having 5 to 50 carbon atoms, (b) substituted or unsubstituted, linear or branched, saturated or unsaturated alkyl groups having 1 to 30 carbon atoms; or combinations thereof. Suitable substitutions and/or linkers include, but are not limited to, ethers, epoxides, amides, esters, and combinations thereof. Beneficial linkers include, but are not limited to, tetravalent aromatic radicals of formula (II), such as

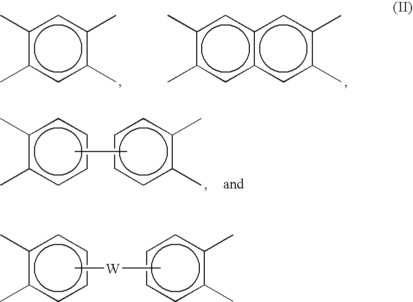

wherein W is a divalent moiety selected from —O—, —S—, —C(O)—, —SO₂—, —SO—, —C_{y}H_{2y}— (y being an integer from 1 to 5), and halogenated derivatives thereof, including perfluoroalkylene groups, or a group of the formula —O-Z-O— wherein the divalent bonds of the —O— or the —O-Z-O— group are in the 3,3′, 3,4′, 4,3′, or the 4,4′ positions, and wherein Z includes, but is not limited, to divalent radicals of formula (III).

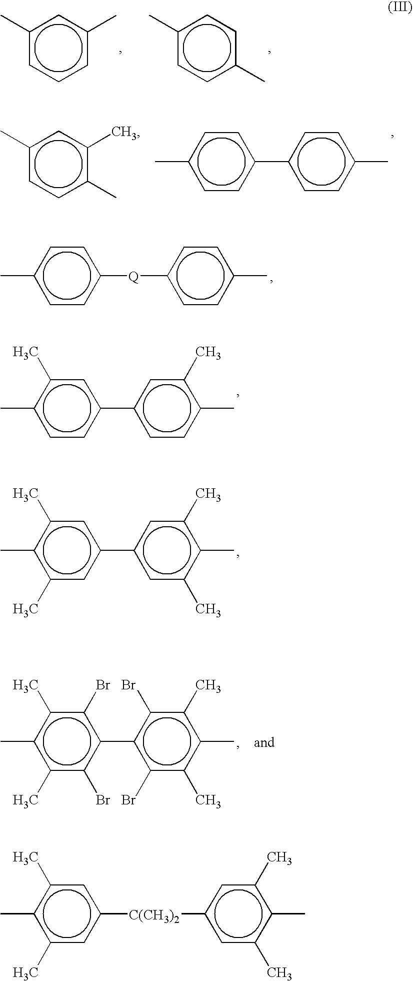

R in formula (I) includes substituted or unsubstituted divalent organic radicals such as (a) aromatic hydrocarbon radicals having 6 to 20 carbon atoms and halogenated derivatives thereof; (b) straight or branched chain alkylene radicals having 2 to 20 carbon atoms; (c) cycloalkylene radicals having 3 to 20 carbon atoms, or (d) divalent radicals of the general formula (IV)

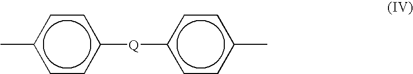

wherein Q includes a divalent moiety selected from —O—, —S—, —C(O)—, —SO₂—, —SO—, —C_{y}H_{2y}— (y being an integer from 1 to 5), and halogenated derivatives thereof, including perfluoroalkylene groups.

In alternative embodiments, the classes of polyimides that may be used in the foam materials include polyamidimides and polyetherimides, particularly those polyetherimides that are melt processable.

In alternative embodiments of the present invention, polyetherimide polymers including more than 1 structural unit of the formula (V) are used. In an alternative embodiment, polyetherimide polymers including 10 to 1000 structural units of the formula (V) are used. In still other alternative embodiments, polyetherimide polymers including 10 to 500 structural units of the formula (V) are used.

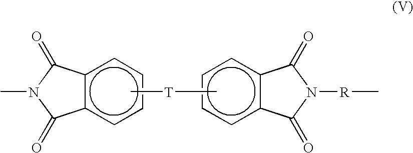

wherein T is —O— or a group of the formula —O-Z-O— wherein the divalent bonds of the —O— or the —O-Z-O— group are in the 3,3′, 3,4′, 4,3′, or the 4,4′ positions, and wherein Z includes, but is not limited, to divalent radicals of formula (III) as defined above.

In one embodiment, the polyetherimide may be a copolymer, which, in addition to the etherimide units described above, further contains polyimide structural units of the formula (VI)

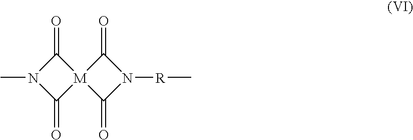

wherein R is as previously defined for formula (I) and M includes, but is not limited to, radicals of formula (VII).

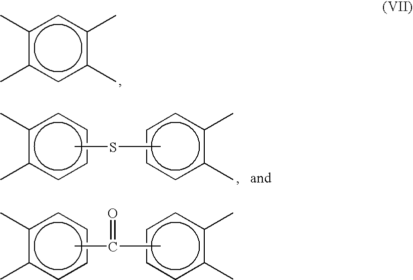

The polyetherimide can be prepared by any of the methods including the reaction of an aromatic bis(ether anhydride) of the formula (VIII)

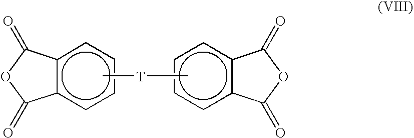

with an organic diamine of the formula (IX)

H₂N—R—NH₂ (IX)

wherein T and R are defined as described above in formulas (I) and (IV).

Illustrative examples of aromatic bis(ether anhydride)s of formula (VIII) include 2,2-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3 -dicarboxyphenoxy)-4′-(3,4-dicarboxyphenoxy)diphenyl sulfide dianhydride; 4-(2,3 -dicarboxyphenoxy)-4′-(3,4-dicarboxyphenoxy)benzophenone dianhydride and 4-(2,3-dicarboxyphenoxy)-4′-(3,4-dicarboxyphenoxy)diphenyl sulfone dianhydride, as well as various mixtures thereof.

The bis(ether anhydride)s may be prepared by the hydrolysis, followed by dehydration, of the reaction product of a nitro substituted phenyl dinitrile with a metal salt of dihydric phenol compound in the presence of a dipolar, aprotic solvent. A beneficial class of aromatic bis(ether anhydride)s included by formula (VIII) above includes, but is not limited to, compounds wherein T is of the formula (X)

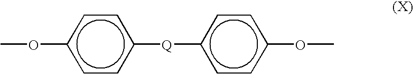

and the ether linkages, for example, are beneficially in the 3,3′, 3,4′, 4,3′, or 4,4′ positions, and mixtures thereof, and where Q is as defined above.

Any diamino compound may be employed in the preparation of the polyimides and/or polyetherimides. Examples of suitable compounds are ethylenediamine, propylenediamine, trimethylenediamine, diethylenetriamine, triethylenetertramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis (3-aminopropyl)amine, 3-methoxyhexamethylenediamine, 1,2-bis(3-aminopropoxy)ethane, bis(3-aminopropyl)sulfide, 1,4-cyclohexanediamine, bis-(4-aminocyclohexyl)methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl)methane, bis(2-chloro-4-amino-3,5-diethylphenyl)methane, bis(4-aminophenyl)propane, 2,4-bis(b-amino-t-butyl) toluene, bis(p-b-amino-t-butylphenyl)ether, bis(p-b-methyl-o-aminophenyl)benzene, bis(p-b-methyl-o-aminopentyl)benzene, 1,3-diamino-4-isopropylbenzene, bis(4-aminophenyl)sulfide, bis(4-aminophenyl)sulfone, bis(4-aminophenyl)ether and 1,3-bis(3-aminopropyl)tetramethyldisiloxane. Mixtures of these compounds may also be present. In one embodiment, the diamino compounds are aromatic diamines, especially m- and p-phenylenediamine and mixtures thereof.

In an exemplary embodiment, the polyetherimide resin includes structural units according to formula (V) wherein each R is independently p-phenylene or m-phenylene or a mixture thereof and T is a divalent radical of the formula (XI)

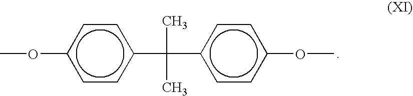

In general, the reactions can be carried out employing solvents such as o-dichlorobenzene, m-cresol/toluene, or the like, to effect a reaction between the anhydride of formula (VIII) and the diamine of formula (IX), at temperatures of 100° C. to 250° C. Alternatively, the polyetherimide may be prepared by melt polymerization of aromatic bis(ether anhydride)s of formula (VIII) and diamines of formula (IX) by heating a mixture of the starting materials to elevated temperatures with concurrent stirring. Generally, melt polymerizations employ temperatures of 200° C. to 400° C. Chain stoppers and branching agents may also be employed in the reaction. When polyetherimide/polyimide copolymers are employed, a dianhydride, such as pyromellitic anhydride, is used in combination with the bis(ether anhydride). The polyetherimide polymers can optionally be prepared from reaction of an aromatic bis(ether anhydride) with an organic diamine in which the diamine is present in the reaction mixture at no more than 0.2 molar excess, and beneficially less than 0.2 molar excess. Under such conditions the polyetherimide resin has less than 15 microequivalents per gram (μeq/g) acid titratable groups, and beneficially less than 10 μeq/g acid titratable groups, as shown by titration with chloroform solution with a solution of 33 weight percent (wt %) hydrobromic acid in glacial acetic acid. Acid-titratable groups are essentially due to amine end-groups in the polyetherimide resin.

Generally, useful polyetherimides have a melt index of 0.1 to 10 grams per minute (g/min), as measured by American Society for Testing Materials (ASTM) D1238 at 295° C., using a 6.6 kilogram (kg) weight. In a select embodiment, the polyetherimide resin has a weight average molecular weight (Mw) of 10,000 to 150,000 grams per mole (g/mole), as measured by gel permeation chromatography, using a polystyrene standard. Such polyetherimide polymers typically have an intrinsic viscosity greater than 0.2 deciliters per gram (dl/g), beneficially 0.35 to 0.7 dl/g measured in m-cresol at 25° C.

In addition to the organic polymer resin, the foam materials of the present invention are made using one or more blowing agents. While the finished foam product is substantially free of the blowing agents, it is contemplated that residual amounts of the one or more blowing agents may remain in the foam material, although these residual amounts are not sufficient to adversely affect the foam characteristics of the foam material.

Accordingly, in one embodiment, the process of forming the polymeric foams uses one or more blowing agents in the continuous process. In one embodiment, the blowing agent or agents are selected from blowing agents having a low boiling point. As used herein, a “low boiling point” blowing agent is beneficially one having, in one embodiment, a boiling point of less than 100 ° C. In another embodiment, a “low boiling point” blowing agent is one having a boiling point of less than 90° C. In still another embodiment, a “low boiling point” blowing agent is one having a boiling point from 50° C. to 85° C. However, there are select embodiments wherein a “low boiling point” blowing agent includes water, carbon dioxide, nitrogen or argon. As such, in these embodiments, the boiling point may be greater than 100° C. or substantially less than 50° C.

Examples of blowing agents that may be used in the present invention include, but are not limited to, low boiling ketones such as acetone, alcohols such as methanol, cyclohexane, esters such as ethyl acetate, or mixtures including at least one of the foregoing blowing agents. In alternative embodiments, carbon dioxide, nitrogen gas, argon and/or even water may be used. In general, any agent capable of being injected and blended into a melt to produce a low density or high density PEI foam material may be used. Chlorinated hydrocarbons and ethers or di-ethers may be used in alternative embodiments if toxicity and formation of peroxides for ethers are not considered a problem. However, in beneficial embodiments, no Freon or related blowing agents are used for environmental reasons. And as the present invention provides a low density or high density PEI foam material manufactured with non-Freon blowing agents, these embodiments are preferred. Ethers may be used in still other alternative embodiments, though it is beneficial in these embodiments to prevent the ethers from forming peroxides and/or preventing their ignition as soon as they exit the die, and/or mix with the air or just come into contact with the high temperature melt or extrusion equipment.

The blowing agents are selected such that they have some solubility in PEI. As discussed, it is contemplated that there may be some residual blowing agent that will remain in the PEI foam for an extended time after extrusion, although the high extrusion temperatures used to form the foam help to drive off most of the blowing agent as the melt exits the die. In alternative embodiments, any of the residual blowing agent may be reduced by exposing the foam material to a heat cycle.

The present invention also uses a sufficient amount of the blowing agent and the blowing agent is selected to be sufficiently soluble to grow the voids into the bubbles that form a foam material having the selected density. As a result, if all of the parameters including solubility of the blowing agent with the PEI melt (at pressure, temperature and shear rate) are balanced and the walls of the bubbles are sufficiently stable such that they do not rupture or coalesce until the viscosity/melt strength of the resin/blowing agent is strong enough to form a stable foam as it cools, the result is a good, uniform, small celled foam having a selected density.

As such, in beneficial embodiments, a blowing agent is selected such that it is a solvent that is only soluble in the polymer under high heat and pressure, but that defuses and evaporates from the polymer at a selected rate to provide plasticization until the polymer cools and is stable.

As a result, the type of blowing agent or agents used will vary depending on the final characteristics of the polymeric foam to be formed. For example, it has been determined that, for lower density foams, certain blowing agents are more useful than others. Conversely, for higher density foams, other blowing agents are more useful. Regardless, the amount of blowing agent or agents used is, in one embodiment, from 1 to 15 percent by weight of the total weight of the PEI. In an alternative embodiment, the amount of blowing agent or agents used is, in one embodiment, from 3 to 10 percent by weight of the total weight of the PEI. The exact amount of blowing agent or agents used will depend on one or more factors including, but not limited to, the selected density of the foam product, the process parameters and/or which blowing agent or mixture of agents is used.

For lower density foams, it is beneficial to select a blowing agent that has a lower boiling point and/or blowing agents that have a substantially lower solubility in the PEI melt in the extruder. The conditions are chosen such that the pressure in the die remains sufficiently high that the resin/blowing agent does not begin to foam until it leaves the die. At that point the blowing agents will expand in the nucleation sights to form bubbles, while also defusing through the bubble walls. The resin i.e. bubble walls stiffen as the blowing agents leave. The foam is controlled at that point by the calibrator, which, in combination with a puller, limits its expansion and adds additional cooling through the plates of the calibrator, which are carefully temperature controlled. The foaming itself cools the resin. The blowing agent(s) is actually not in a liquid state, but is dispersed within the resin and as such does not undergo a phase change.

For higher density foams, it is beneficial to select a blowing agent that has a higher boiling point and/or blowing agents that have a higher solubility in the PEI melt in the extruder. These higher boiling point blowing agents do not maintain as high a pressure in the extruder die such that they do not expand the PEI melt as much as the melt temperature starts to drop. As a result, when the foaming begins, it does so with a less-expanded material such that when the foam material cools due to the loss of the blowing agent to the atmosphere, a higher density foam material is formed.

Therefore, by varying the type of blowing agent used, the present invention provides PEI foam materials having a lower density or having a higher density as compared to prior art PEI foam materials.

In addition to the blowing agent, though, the type of foam to be produced may also vary depending on other factors such as the presence of nucleating agent particles, the loading and/or process conditions, and the type of equipment used to form the foam materials. The nucleating agent helps control the foam structure by providing a site for bubble formation, and the greater the number of sights, the greater the number of bubbles and the less dense the final product can be, depending on processing conditions. As such, for lower density foams, a larger amount of nucleating agent may be used while no or very small amounts of nucleating agent may be used for embodiments where higher density foams or larger bubbles are to be formed.

Accordingly, in one embodiment of the present invention, a lower density polymeric foam material is formed wherein the resulting foam has a density from 20 to 50 g/L. Accordingly, in these embodiments the present invention includes the use of a nucleating agent. Nucleating agents that may be used in the present invention include, but are not limited to, metallic oxides such as titanium dioxide, clays, talc, silicates, silica, aluminates, barites, titanates, borates, nitrides and even some finely divided, unreactive metals, carbon-based materials (such as diamonds, carbon black and even nanotubes) or combinations including at least one of the foregoing agents. In alternative embodiments, silicon and any crosslinked organic material that is rigid and insoluble at the processing temperature may also function as nucleating agents.

In alternative embodiments, other fillers may be used provided they have the same effect as a nucleating agent in terms of providing a site for bubble formation. This includes fibrous fillers such as aramid fibers, carbon fibers, glass fibers, mineral fibers, or combinations including at least one of the foregoing fibers. In still other embodiments, excess amounts of fibers above what is used for nucleating purposes may be used, with the additional fibers providing other characteristics to the foam material. For example, excess fiber loading may be used to provide additional stiffness and/or reinforcement of the foam material. Accordingly, in one embodiment, fibers may be included in the foam materials in amounts of up to 60% by weight of the total weight of the foam material.

When used, in one embodiment, the amount of nucleating agent used is from 0.1 to 5 percent by weight of the total weight of the PEI. In another embodiment, the amount of nucleating agent used is from 0.2 to 3 percent by weight of the total weight of the PEI. In still another embodiment, the amount of nucleating agent used is from 0.5 to 1 percent by weight of the total weight of the PEI.

In addition to the amount, the type of nucleating agent can be used to help control the density of the foam. Certain nucleating agents have different numbers of nucleating sites per particle and, therefore help control the size of the bubbles formed thereon as well as the thickness of the walls of the bubbles. In general, the thickness of the walls depends on the polymer and the properties of the polymer melt under the particular conditions, and including the effects of the blowing agent. The density will be a function of both the size and number of bubbles per unit volume, be it due to large or small bubbles. The thicker the bubble walls are, the denser the foam will be. In general, nucleating agents having few nucleating sites result in larger bubbles. Conversely, nucleating agents having many nucleating sites result in smaller bubbles. In those embodiments that do not use a nucleating agent, a columnar bubble structure develops that exhibits higher compressive strength.

In addition, controlling the process parameters may be used to help form a PEI foam material having a selected density. To produce a lower density longer cooling times are required because of poor heat transfer, thus slower processing, lower throughput is required. Equipment modifications to provide for longer cooling (a longer calibrator for instance) could improve throughput rates as long as initiation of foaming could be prevented in the die.

In addition to the lower density foams, the present invention includes in alternative embodiments a higher density polymeric foam material wherein the resulting foam has a density from 120 to 300 g/L. The high density PEI foam material, in select embodiments, does not include the use of a nucleating agent. Without the use of a nucleating agent a columnar bubble structure develops that exhibits higher compressive strength and may result in a denser foam material.

As with the lower density foams, controlling the process parameters may be utilized to help form a higher density foam material.

In those embodiments wherein a dense foam material is formed, low levels of supercritical CO₂ may be used in lieu of the nucleating agent for lower density foams. When used, in one embodiment, the amount of CO₂ used is from 0.01 to 5 percent by weight of the total weight of the PEI. In another embodiment, the amount of CO₂ used is from 0.1 to 1.0 percent by weight of the total weight of the PEI. In still another embodiment, the amount of CO₂ used is from 0.2 to 0.4 percent by weight of the total weight of the PEI.

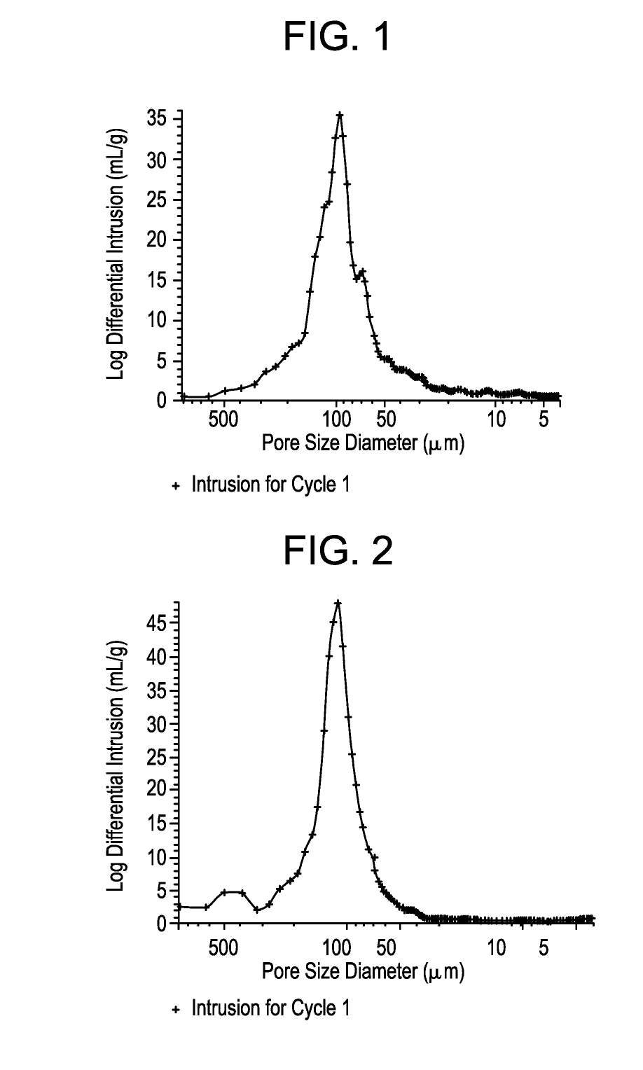

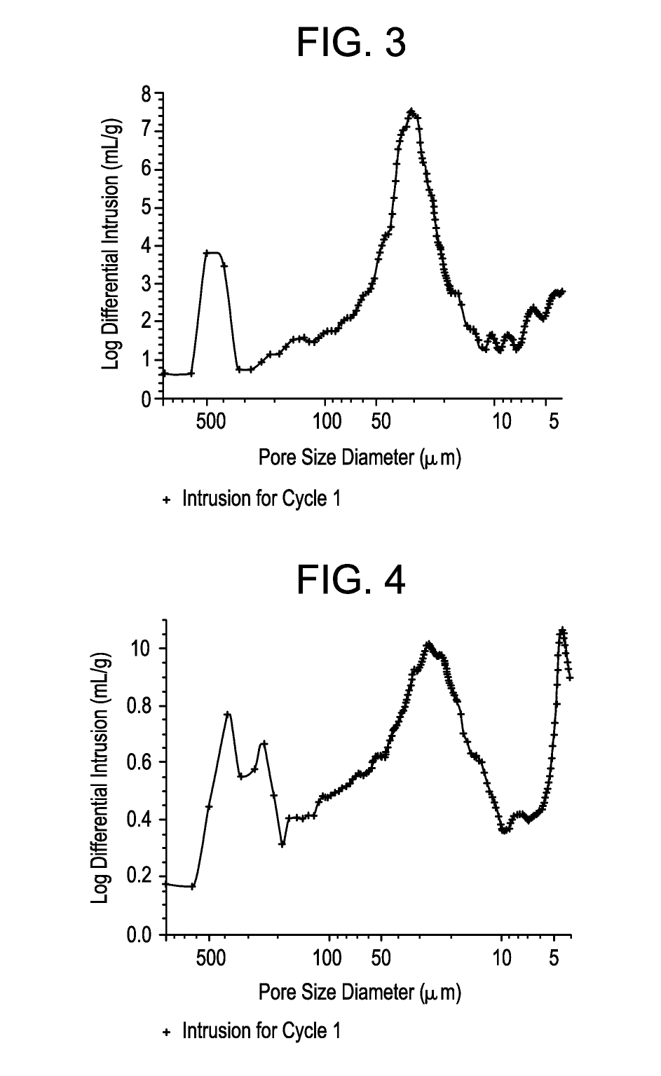

The process of the present invention is capable of forming a foam material that has a substantially uniform cell size. As used herein, a “substantially uniform cell size” refers to a foam material wherein at least 50% of the pores are within ±20 microns of a single pore size selected on the basis of the density of the foam material. As a result, a Log Differential Intrusion vs. Pore Size graph of the foam material would reflect a unimodal distribution. In addition, the Log Differential Intrusion (in mL/g) is higher (i.e. greater than 10) as compared to batch processes. In another embodiment, a “substantially uniform cell size” refers to a foam material wherein at least 70% of the pores are within ±20 microns of a single pore size selected on the basis of the density of the foam material. In addition, the Log Differential Intrusion (in mL/g) is greater than 20. The advantage to a uniform cell size is better mechanical properties since larger cells act as a weak point in the foam, which may initiate a failure. As can be seen in FIGS. 1-4, the foam materials made according to the present invention (FIGS. 1 and 2) have a single “spike” in the distribution of cell size while foam materials made according to prior art methods (FIGS. 3 and 4) do not.

The foam materials of the present invention may be formed using any method capable of forming lower or higher density PEI foam materials. In one embodiment, the PEI foam materials are formed using an extrusion process. In this process, the PEI resin and any nucleating agent are first melt blended together in a primary extruder. The blowing agent is then fed into the primary extruder and mixed into the melt blend under high pressure and temperature in the last sections of the primary extruder. The melt is then fed under pressure to a secondary extruder, which is used to cool the foam material and transport the polyetherimide foam material through a die to a calibrator to form the foam material. The calibrator helps to control the cooling rate of the foam material and, therefore, is beneficial in helping to control the thickness, width and density of the foam material. The die is operated at a specific temperature range and pressure range to provide the necessary melt strength to and to suppress premature foaming in the die. In one embodiment, a single screw extruder is used for both the primary extruder and the secondary extruder. In an alternative embodiment, a twin-screw extruder is used for both the primary extruder and the secondary extruder. In yet another alternative embodiment, a single screw extruder is used for one of the primary extruder or the secondary extruder and a twin-screw extruder is used for the other.

As discussed, the present invention provides polymeric foam materials that are in a wider range of densities as compared to prior art foam materials. The present invention provides PEI form materials having densities from 25 to 50 g/L as compared to densities of 60 to 110 g/L for most PEI foams. In addition, the present invention provides PEI form materials having densities from 120 to 300 g/L, again above the range of most PEI foam materials. This wider range is available due to one or more factors including, but not limited to, the number and/or types of blowing agents and nucleating agent used, the type and/or design of the equipment used to form the foam materials, the use of a continuous process to form the polymeric foam materials, and/or the processing conditions used to form the polymeric foam materials of the present invention.

In addition, as the methods of making the foams enable foams to be formed having a controlled density, it is also possible to vary the method to enable a foam material having a graded density to be manufactured. For example, the conditions in the calibrator can be altered slightly during the foam formation such that the foam becomes gradually denser or gradually lighter such that the resulting foam has a graded density along the length of the foam.

Therefore, as a result of having a wide range of cell densities that can be manufactured, the resulting polymeric foam may be used in a larger number of applications heretofore unavailable to polymeric foam due to cost and/or characteristics of the foam. The lower density foam exhibits sufficient mechanical properties to be considered as a substitute for “crush core” applications, where its low density and ease of lamination outperform the current, thermoset “honeycomb” material. The higher density foam offers excellent mechanical properties with capability of being thermoformable. Pure PEI resin generally contains no ionic materials and, as a result, offers excellent dielectric properties and radar transparency. Foamed PEI resin provides substantially similar thermal properties, but at low density compared to unfoamed PEI resin, making the foamed PEI resin especially useful for “raydome” or radar cover applications.

The PEI foam materials, as formed may be in a variety of shapes, such as foam boards, foam tubes or any shape of foam material capable of being formed in a calibrator.

All cited patents, patent applications, and other references are incorporated herein by reference in their entirety. The invention is further illustrated by the following non-limiting examples.

### EXAMPLES

Several polyetherimide foam materials were made. In these samples, PEI resin (ULTEM™ 1000 PEI resin pellets available from SABIC Innovative Plastics) were melt-blended in a Berstorff Schaumex® twin-screw extruder with varying levels of talc (Microtuff AG 609), acetone, methanol and/or carbon dioxide, depending on whether a less dense foam or a more dense foam was to be formed. The melt was then fed under pressure to a second Berstorff twin-screw extruder, which was used to cool the melt blend. From there, the melt blend was transported through a die to a calibrator where foaming of the product occurred to form the final foam material.

Table 1 shows the compositional make-up for three examples of PEI foam made according to the concepts of the present invention. Table 2 provides the processing parameters for each sample as well as the resulting physical characteristics of each material. As may be seen, the processes of the present invention were able to form a PEI foam having a high use temperature while forming both high density and low density foams, and at densities heretofore unable to be produced using conventional batch processes.

As seen in the examples, lower density foam materials can be formed using process parameters that result in lower amounts of material being formed but being processed for longer periods of time. While the processing conditions can be important in selecting the final density of the product, the relationship is not as simple as longer time/slower rate resulting in higher or lower density foam. Lower rates will permit better cooling of the melt, which may make result in lower pressures in the die causing premature foaming in the die. Almost all parameters have to be adjusted to control foam density including rate, screw speed, blowing agent type, etc. All of the parameters interact, although.

TABLE 1

| Composition: | Sample 1 | Sample 2 | Sample 3 |
|---|---|---|---|
| ULTEM ™ 1000 PEI resin pellets | 100 parts | 100 parts | 100 parts |
| Talc (Microtuff AG 609, densified) | 1.0 parts | 0.5 parts | 0.0 parts |
| Acetone | 8.0 parts | 4.8 parts | 6.0 parts |
| Methanol | | 1.2 parts | 0.0 parts |
| CO₂ | | | 0.29 parts |

TABLE 2

| | Feed Rate | Screw Speed | Melt Temp. | Screw Speed | Melt Temp. | Melt Press. | Density |
|---|---|---|---|---|---|---|---|
| Sample | Kg/hr | (Primary) rpm | ° C. | (Cooling) rpm | ° C. | Bar | g/L |
| 1 | 50 | 90 | 380 | 7 | 226 | 64 | 27 |
| 2 | 50 | 100 | 380 | 5 | 228 | 87 | 44 |
| 3 | 100 | 290 | 380 | 8 | 237 | 110 | 230 |

In regards to the prior art batch processes, and as discussed previously, the foam materials of the present invention also have a substantially uniform cell size. This may be seen in FIGS. 1-4. As can be seen in FIG. 1 (60 kg/m³ density foam material) and FIG. 2 (80 kg/m³ density foam material), the Log Differential Intrusion vs. Pore Size charts of these two materials show a unimodal distribution, with the Log Differential Intrusion (mL/g) near 35 at a pore size of app. 90 for the 60 kg/m³ density foam material and a Log Differential Intrusion (mL/g) near 48 at a pore size of app. 110 for the 80 kg/m³ density foam material.

Conversely, as may be seen in FIGS. 3 and 4, a batch process for making a 60 kg/m³ density foam material (FIG. 3) and a batch process for making a 80 kg/m³ density foam material (FIG. 4) result in much lower Log Differential Intrusions (less than 10) with multiple peaks in the distribution along pore size, such that there is a bi-modal or even multi-modal distribution of cell sizes in these foam materials.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

1. A polyetherimide foam material having a density of 25 g/L to 50 g/L.

2. The polyetherimide foam material of claim 1, wherein the polyetherimide foam material has a substantially uniform cell size.

3. The polyetherimide foam material of claim 1, further comprising from 1 to 60% by weight of a fiber.

4. The polyetherimide foam material of claim 3, wherein the fiber is selected from aramid fibers, carbon fibers, glass fibers, mineral fibers, or combinations including at least one of the foregoing fibers.

5. The polyetherimide foam material of claim 1, wherein the foam material has a graded density along a length of the foam.

6. An article of manufacture comprising the polyetherimide foam material of claim 1.

7. A polyetherimide foam material having a density of 120 g/L to 300 g/L.

8. The polyetherimide foam material of claim 7, wherein the polyetherimide foam material has a substantially uniform cell size.

9. The polyetherimide foam material of claim 7, further comprising from 1 to 60% by weight of a fiber.

10. The polyetherimide foam material of claim 9, wherein the fiber is selected from aramid fibers, carbon fibers, glass fibers, mineral fibers, or combinations including at least one of the foregoing fibers.

11. The polyetherimide foam material of claim 7, wherein the foam material has a graded density along a length of the foam.

12. An article of manufacture comprising the polyetherimide foam material of claim 7.
